(19) United States
(12) Patent Application Publication
(10) Pub. No.: US 2024/0052178 A1
(43) Pub. Date: Feb. 15, 2024

(54) Steel Protective Coating Compositions, Methods of Their Manufacture, and Methods of Their Use

(71) Applicant: Thor Custom Steel Coatings LLC, Michigan City, IN (US)

(72) Inventor: Jonathan Kerry Winters, Michigan City, IN (US)

(21) Appl. No.: 18/381,242

(22) Filed: Oct. 18, 2023

Related U.S. Application Data
(62) Division of application No. 18/084,533, filed on Dec. 19, 2022.
Application No. 18/084,533 is a continuation-in-part of application No. 17/677,939, filed on Feb. 22, 2022.
(60) Provisional application No. 63/152,533, filed on Feb. 23, 2021.

(51) Int. Cl. C09D 5/08; C08K 3/08; C08K 5/01; C08G 77/62; C08K 5/3412; C08K 5/00; B05D 1/28; B21D 22/02; C21D 9/46; C08K 5/5399

(52) U.S. Cl. CPC C09D 5/084; C08K 3/08; C08K 5/01; C08G 77/62; C08K 5/3412; C08K 5/0091; B05D 1/28; B21D 22/02; C21D 9/46; C08K 5/5399; B05D 2202/10; C08K 2003/0812; Y10T 428/31663

(57) ABSTRACT

Steel sheet coating compositions or polymeric resin or ceramic properties are produced by admixing an aluminum coordinate complex and an aluminum resin, a polysilazane as a source of silicon, an organic solvent, an organic synthesis catalyst, and a non-metallic, non-ionic, low-nucleophilic base. The admixed coating is applied to sheet steel prior to hot-stamping in order to inhibit formation of iron oxides and to improve steel sheet surface characteristics.

### RELATED APPLICATION

The present application is a Divisional Application that claims the benefit of prior U.S. Continuation-In-Part application Ser. No. 18/084,533, filed Dec. 19, 2022, which is incorporated herein by reference, that claims the benefit of prior U.S. Nonprovisional patent application Ser. No. 17/677,939 filed Feb. 22, 2022, which is incorporated herein by reference that claims the benefit of, prior U.S. Provisional Patent Application Ser. No. 63/152,533, filed Feb. 23, 2021, which is incorporated herein by reference.

### FIELD OF THE INVENTION

The present invention relates generally to steel sheets provided with aluminum-based coating compositions for protecting the steel sheet from unwanted oxidation and oxide formation that occurs during the metallurgical process of heat-stamping. The compositions of the invention relate to the scientific fields and subjects of inorganic chemistry, organic chemistry, metallurgy, ceramics, and steel fabrication.

### BACKGROUND OF THE INVENTION

The steel industry continually searches for novel methods and technologies to lower the costs of producing steel. This includes all factors that are a part of the cost of steelmaking, including materials, energy, labor, and environmental cleanup. For example, the automobile industry, which is an indispensable means of transport in daily life and activities, is constantly requiring its sources of steel automobile components to deliver components that reduce automobile body weight, but also that increase the structural integrity and strength of such components, particularly to enable automobile designers and engineers to develop auto body structural members that improve automobile crashworthiness and passenger safety. The structure of an automobile is formed largely of steel, particularly steel sheet, and reducing the weight of the steel sheet is essential for vehicle body weight reduction. As just pointed out, however, mere reduction of steel sheet weight is not a sufficient design criterion because the mechanical strength of the steel sheet must also be ensured. Such requirements for steel sheet are not limited to the automaking industry but also apply similarly to various other manufacturing sectors, for example appliances. Research and development has therefore been conducted with regard to steel sheet that, by enhancing the mechanical strength of the steel sheet, is capable of maintaining or increasing such mechanical strength even when the sheet steel is made thinner than the steel sheet used previously.

A steel material having high mechanical strength generally tends to decline in shape flexibility performance and formability performance during bending and other forming movements due to metal fatigue, so that the metalworking itself becomes more and more challenging when the desired final shape becomes more complex. An important case in point is when the steel sheet piece is to take on some variation of an accordion-like corrugated article.

One means available for overcoming this formability problem is the so called “hot stamping” method (variously also referred to as heat-stamping, hot-pressing, high-temperature stamping, or die-quenching, etc.). In the hot stamping method, the steel material to be formed is initially heated to a high temperature, and then the steel sheet that has been softened by the heating is stamped and then cooled. Since the hot stamping method softens the steel material by initially heating it to a high temperature, the material can be readily stamped and thus strength hardened, and additionally the mechanical strength of the material can be increased by the quenching effect of rapid cooling subsequent to the stamp-forming. The hot stamping method therefore makes it possible to obtain a formed article that simultaneously achieves good shape-ability and high mechanical strength. As disclosed in U.K. Patent 1,490,535, the disclosure of which is incorporated herein by reference, according to the technology of hot press forming, it is possible to form a steel sheet into a complicated shape with good dimensional accuracy since the steel sheet is softer and more ductile at high temperature.

Another advantage of hot press forming is that strengthening of the steel sheet due to crystal structure martensite transformation (so-called work hardening) can be simultaneously achieved, in parallel, by heating the steel sheet to the crystal structure austenite region and then performing rapid quenching at the same time as press forming in the die. However, since hot press forming is a method in which a heated steel sheet is subjected to working, the surface of the steel sheet to be worked is unavoidably oxidized. Even if the steel sheet is heated in a non-oxidizing atmosphere in a heating furnace, the sheet retains the possibility of contacting the atmosphere, for example, when it is removed from the furnace before press forming, resulting in the oxidation formation of iron oxides on the surface of the steel sheet. These iron oxides have the cost disadvantage that they may fall off during press forming and adhere to stamping or forming dies, thereby decreasing productivity and increasing cost and expense. Furthermore, an oxide film (i.e. scale on the surface of the steel) made up of such iron oxides remains on a product produced by press forming and worsens its appearance, thereby necessitating it removal by sanding, grinding, shot blasting, and the like, all of which are time and labor intensive and raise the cost of production.

Furthermore, if these oxide films remain on a press-formed product, in a situation where the product is subsequently to be coated with a paint, the resulting painted surface film has poor adhesion to the steel sheet and the product fails of its essential purpose of constituting a paint-finished steel piece. Furthermore, if the iron oxide layer is removed, then the uncoated steel sheet by itself will have very poor rust prevention properties. Even if the alternative of using a low alloy steel or a stainless steel is utilized so as to prevent the formation of such oxide films during heating prior to hot press forming and to thereby guarantee corrosion resistance, it is impossible to entirely prevent the formation of an oxide film, and the total costs have then become significantly higher than they would be for plain steel.

Another strategy to prevent such surface oxidation of sheet steel at the time of hot press forming, is to use a non-oxidizing atmosphere for both the atmosphere present at the time of heating and the atmosphere present during the entire pressing process, but this alternative strategy also results in a large increase in equipment and energy costs.

These multiple additional costs mean that even the present time, hot press-forming is not sufficiently utilized industry-wide. This leads to an examination of alternative approaches to the problem of reducing oxide formation in hot press-forming steel. A review of current technologies which has been disclosed in patent applications is now presented.

As noted, one advantage of hot press forming is that heat treatment may be performed simultaneously with press forming. It is therefore proposed in JP 07-116900A (1995) to simultaneously perform surface treatment at press forming time. However, there is no disclosure therein with respect to a means of solving the above-described problems due to surface oxidation. A steel sheet for hot working is proposed in JP 2000 38640A, that has been coated with aluminum in order to provide the steel sheet with resistance to oxidation at the time of hot working. However, this processed steel sheet has been found to be too expensive compared to plain steel. As proposed in JP 06-240414A (1994), from just the standpoint of improving rust preventing properties or corrosion resistance, the addition of alloying elements such as Cr and Mo to the steel composition of a steel material is employed in some cases. (The entire disclosures of the above cited Japanese publications is incorporated herein by reference). However again, such countermeasures excessively raise the costs of the steel. Furthermore, when the option is pursued of adding Cr and Mo, there is a resultant problem of a deterioration in press formability due to added presence of these alloying elements. Any of various materials, including organic materials and inorganic materials, have been generally used for antioxidant coatings on steel sheet. Among them, steel sheet having a zinc-based coating that provides the steel sheet with a sacrificial corrosion protection effect is widely used for automotive steel sheet and the like. However, the heating temperature in hot stamping (700 to 1000° C.) is higher than, for example, the decomposition temperatures of organic materials and the boiling points of Zn-based and other metallic materials, so that the effect of heating to such temperatures during hot stamping may sometimes evaporate an applied surface-coating layer and then cause marked degradation of the sheet steel surface properties.

Therefore, it has been found that for steel sheet that is to be subjected to hot stamping involving high-temperature heating, it is preferable to use a steel sheet having an Al-based metal coating, which has a higher boiling point than an organic material coating or a Zn-based metal coating, referred to in the industry as aluminum plated steel sheet. Providing an Al-based metal coating prevents scale from adhering to the steel sheet surface and improves productivity by making descaling or other such scale removal processes unnecessary. Moreover, corrosion resistance after painting the sheet improves because the Al-based metal coating has a corrosion-proofing effect. The prior art describes a method which performs hot stamping using an aluminum-plated steel sheet obtained by coating a steel having a predetermined steel composition with an Al-based metal coating. However, when an Al-based metal coating is applied, and depending on the preheating conditions prior to stamping in the hot stamping process, it may happen that the Al coating first melts and is then changed to an Al—Fe alloy layer by the process of Fe diffusion from the steel sheet, whereby such newly formed Al—Fe alloy comes to extend to the steel sheet surface through the growth of the Al—Fe alloy. This compound layer is called the alloy layer. Since this alloy layer has the property of being extremely hard, processing scratches are formed by contact with the die during stamping. The surface of the Al—Fe alloy layer by its nature is relatively resistant to slipping and is poor in lubricity, a desirable property in stamping and rolling operations. In addition, the Al—Fe alloy layer is not only hard but is relatively friable and is thus susceptible to cracking, so that formability is liable to decrease owing to cracking, flaking, and powdering of the plating layer. Moreover, the quality of the stamped product is degraded by adhesion to the die of exfoliated Al—Fe alloy layer particles and of the strongly scored surface of the Al—Fe alloy. This makes it necessary to remove the Al—Fe alloy powder that has adhered to the die during repair, which again lowers productivity and increases cost. In addition, the Al—Fe alloy allow is relatively low in reactivity in situ with conventional phosphate metal treatment, which hinders the formation of the sought-after phosphate film that is ordinarily produced by a chemical conversion reaction that is part of electrocoating pretreatment. There is also a tradeoff between increasing the weight of the Al plating layer in order to improve paint adhesion, but where the increase in weight tends to aggravate the die adherence problem.

There is therefore a general need for steel coating compositions that have the ability to: maintain coating integrity under conditions of complex steel shape stamping; withstand the high temperatures and physical forces prevalent during steel hot-press forming; display properties of improved inhibition of iron oxide formation and oxidation prevention; reduce iron oxide die adhesion and clean-up; show improved paint adhesion; reduce rust formation; reduce reliance on the use of low alloy steel or stainless steel; reduce reliance on the need for non-oxidizing atmospheres in a steel mill; reduce reliance on Cr and Mo alloy elements; exhibit higher melting temperatures and decomposition temperatures; resist high temperature steel surface evaporation; resist the formation of Al—Fe alloys in situ; reduce adhesion of deposits onto die tooling surfaces; reduce surface scratches; display acceptable lubricity; be resistant to flaking, cracking and powdering; avoid interference with phosphate film electrocoating; form a film that is electrically conductive; have lowered surface coating weight; have reduced manufacturing costs; show greater chemical stability; yield reliably repeatable batch manufacture; have the potential for scalability as the size of batch outputs increases; have better affordability; have greater ease of use; and lend themselves readily to storage, transportation and distribution. The compositions of the invention meet these needs, enable a method of their manufacture, and enable a method of their use, resulting in steel coated products that are made by these methods and that will have novel and advantageous properties over coatings of prior art compositions or manufacturing processes.

This background information is provided to present and disclose information believed by the applicants to be of possible relevance to the present invention. No admission is necessarily intended, nor should be construed, that any of the preceding information constitutes prior art against the present invention.

### SUMMARY OF THE INVENTION

In summary of a most preferred embodiment of the invention, it is an oxidation-protective coating composition for steel sheets comprising an aromatic organic solvent, at least one source of aluminum, a silazane and, an organic synthesis catalyst. The aromatic organic solvent may advantageously be selected from one or more compounds of the group consisting of 1,2-diethylbenzene, 1,3-diethylbenzene, 1,4-diethylbenzene, 1,2,3-trimethylbenzene, 1,2,4-trimethylbenzene, 1,3,5-trimethylbenzene, polyethylbenzene, bicyclo[4.4.0]deca-1,3,5,7,9-pentaene, 2-methylindole, and 2-phenylpropane. A source of aluminum is present in the form of an aluminum pigment, which may be present in the form of a coordination complex of aluminum, preferably aluminum acetylacetonate. A preferred silazane is a polysilazane polymer resin comprising silicon and nitrogen, and an alternative preferred embodiment uses a polysilazane that is an organic polysilazane. However, equally advantageous alternative embodiments may comprise an inorganic polysilazane, or admixtures of organic and inorganic polysilazines. The organic synthesis catalyst may be an organohetercyclic compound, preferably an azepane, and more preferably 1,8-diazabicyclo[5.4.0]undec-7-ene. Additionally, the composition may additionally comprise an organophosphorus compound, preferably a phosphazene, and more preferably for example 2-tert-Butylimino-2-diethylamino-1,3-dimethylperhydro-1,3,2-diaza phosphorine.

In terms of concentration ranges, the aromatic organic solvent is preferably present in a w/w concentration of from 30% to 60%; the aluminum is preferably present in a w/w concentration of from 5% to 25%; the silazane is preferably present in a w/w concentration of from 20% to 60%; and the organic synthesis catalyst is preferably present in a concentration of from 0.5% to 5%. The aromatic organic solvent is more preferably present in a w/w concentration of from 40% to 50%; the aluminum is more preferably present in a w/w concentration of from 10% to 20%; the silazane is more preferably present in a w/w concentration of from 30% to 50%; and the organic synthesis catalyst is more preferably present in a concentration of from 1% to 4%. The aromatic organic solvent is most preferably present in a w/w concentration of 44 to 45%; the aluminum is most preferably present in a w/w concentration of from 12% to 14%; the silazane is most preferably present in a w/w concentration of from 38% to 42%; and the organic synthesis catalyst is most preferably present in a w/w concentration of approximately 2%.

A preferred method of protecting surfaces of carbon steel during high temperature stamping comprises roller-coating the surfaces of the steel to be stamped with a coating comprised of any of the above described compositions.

The invention further comprises a method of making or furthermore applying the steel oxidative-protective coating compositions of those as described above, comprising the steps of admixing the aromatic organic solvent, the aluminum, the silazane, and the catalyst to a homogeneous consistency admixture; calculating an amount of time needed to achieve an optimized drying time or cure rate of this admixture; adding the selected organophosphorous compound to the admixture product in an amount sufficient to obtain the optimized drying or cure rate; and applying the optimized admixture to a steel article in need of protection from oxidation, by applying the dry-time or cure rate-optimized admixture to the steel article prior to heat-stamping that steel article.

The invention further comprises a coated steel sheet that has been prepared for heat-stamping, in accordance with the method as described above.

Additionally the invention preferably comprises an aluminum-plated steel sheet for hot-stamping, comprising said steel sheet having at least one surface coated by a composition comprising an aromatic organic solvent, a source of aluminum, a silazane; and an organic synthesis catalyst, where each component may be present in any of the preferred alternative concentrations described above, and in any of the ranges of concentrations described above.

In another summary, another preferred embodiment of the invention comprises an oxidation-protective coating composition for steel sheets comprising the chemical components of: an aromatic organic solvent; at least one source of aluminum; a silazane; an organic synthesis catalyst; or additionally an organophosphorus compound.

Most preferably, these coating compositions of the invention have an aromatic organic solvent present during the admixture process of making the compositions, where the aromatic organic solvent is preferably selected from one or more solvents such as 1,2-diethylbenzene, 1,3-diethylbenzene, 1,4-diethylbenzene, 1,2,3-trimethylbenzene, 1,2,4-trimethylbenzene, 1,3,5-trimethylbenzene, polyethylbenzene, bicyclo[4.4.0]deca-1,3,5,7,9-pentaene, 2-methylindole, or 2-phenylpropane. The coating compositions of the invention utilize at least one source of aluminum, most preferably sourced as an aluminum pigment, while another source or an additional source of aluminum may be a coordination complex of aluminum. A preferred coordination complex of aluminum is aluminum acetylacetonate.

The coating compositions of the present invention utilize a silazane. Preferably, the silazane component is a polysilazane, which may be a polymer resin comprised of silicon and nitrogen, and the polysilazane furthermore may be an organic silazane or an inorganic polysilazane. The coating compositions of the invention preferably use an organic synthesis catalyst, more preferably an organohetercyclic compound, and most preferably an azepane. A particularly advantageous organic synthesis catalyst is 1,8-diazabicyclo[5.4.0]undec-7-ene.

The coating compositions may optioanally alternatively or additionally comprise an organophosphorus compound, preferably a phosphazene. A particularly preferred phosphazene is 2-tert-Butylimino-2-diethylamino-1,3-dimethylperhydro-1,3,2-diaza phosphorine.

The aforesaid components of the compositions of the invention are typically present as the aromatic organic solvent in a w/w concentration of from 30% to 60%; the aluminum sources present in a w/w concentration of from 5% to 25%; the silazane present in a w/w concentration of from 20% to 60%; the organophosphorus, when it is additionally used, being present in a w/w concentration of from 5% to 25%; and the organic synthesis catalyst present in a w/w concentration of from 0.5% to 5%. More preferable ranges of components of the compositions of the invention are: aromatic organic solvent present in a w/w concentration of from 40% to 50%; aluminum sources present in a w/w concentration of from 10% to 20%; silazane present in a w/w concentration of from 30% to 50%; organophosphorus, when it is additionally used, present in a w/w concentration of from 10% to 20%; and organic synthesis catalyst present in a concentration of from 1% to 4%. In a highly preferred embodiment of the coating compositions of the invention, the aromatic organic solvent is present in a w/w concentration of 44% to 45%; the aluminum sources are present in a w/w concentration of from 12% to 14%; the silazane is present in a w/w concentration of from 38% to 42%; the organophosphorus, when it is additionally used, is present in a w/w concentration of approximately 20%; and the organic synthesis catalyst is present in a w/w concentration of approximately 2%.

The present invention also covers a method of protecting surfaces of steel, preferably carbon steel during high temperature stamping, comprising coating the surfaces of the steel to be stamped with a coating composition made up of an aromatic organic solvent; at least one source of aluminum; a silazane; an organic synthesis catalyst; and optionally additionally an organophosphorus compound, each chemical component present in the w/w ranges described above.

The protective coating compositions of the invention are made by a method comprising the steps of admixing the aromatic organic solvent, at least one aluminum source, the silazane, and the catalyst, in an amount calculated to achieve desired drying time or cure time, to a homogeneous consistency; achieving a optimally desired coating admixture drying time or cure time by selectively adding sufficient amounts of aluminum and optionally an organophosphorus compound to the admixture product; and applying the optimized dry-time or cure-time admixture product to a steel article in need of protection from oxidation, by applying the admixture to such a steel article prior to heat-stamping it.

By following this composition preparation method there will be produced a coated steel sheet, having a chemical surface layer composition that is novel and unique, and that is now prepared for heat-stamping, which will be protected against oxidation that tends to otherwise take place during a heat-stamping process.

The compositions of the invention are intended to be used in the preparation of sheet steel generally, and carbon steel in particular, to produce a sheet of steel that can withstand the oxidative effects of oxygen present in the steel production factory or mill, whose oxidative effects are otherwise made more corrosive by the high temperatures and high stamping forces typically utilized in steel heat-stamping manufacturing.

### DETAILED DESCRIPTION OF THE INVENTION

The present invention in its varying embodiments will now be described more fully. This invention may, however, be embodied in many different forms and should not be construed as being limited to the embodiments set forth herein. Rather, these embodiments are provided so that this disclosure will be thorough and complete, and will fully convey the scope of the invention to those of ordinary skill in the art.

Although the detailed description of this Specification contains many specifics for the purposes of illustration, a person of ordinary skill in the art will appreciate that many variations and alterations to the following details are within the scope of the invention. Accordingly, the following embodiments of the invention are set forth without any loss or diminution of generality to, and without imposing limitations upon, the claimed invention.

As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art on how to make or use the embodiments of the disclosure and are not intended to limit the scope of the disclosure of the invention, which is defined solely by the claims.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

Abbreviations, nomenclature, and technical & non-technical term definitions as used in these Examples are as follows:

The phrase “a” or “an” in the context of an entity or moiety as used herein refers to one or more of that entity or moiety, as in for example, “a” compound refers to one or more compounds or at least one compound. As such, the terms “a” (or “an”), “one or more,” and “at least one,” and “and or “can” be used interchangeably. The term “about” has its plain and ordinary meaning of “approximately.” Regarding metal ion ratios and dosing amounts, the qualifier “about” reflects the standard experimental error. The terms “optional” or “optionally” as used herein means that a subsequently described event or circumstance may, but need not, occur and that the description includes instances where the event or circumstance occurs and instances in which it does not.

The term “mixing” or “efficient mixing” as used herein is not limited to the same compounding process; it involves all mixing methods in a manufacturing process.

The compositions of the present invention can be prepared readily according to the following Examples or modifications thereof using readily available starting materials, reagents and conventional synthesis procedures. In these reactions, it is also possible to make use of variants which are themselves known to those of ordinary skill in this art, but these are not mentioned in greater detail.

The most preferred compositions and their constituent compounds of the invention are any or all of those specifically set forth in these Examples. These compositions are not, however, to be construed as forming the only genus that is considered as the invention, and any combination of the compositions and constituent compounds or their moieties may itself form a genus. The following examples further illustrate details for the preparation and the quantitative and qualitative analysis of the compounds of the present invention. Those skilled in the art will readily understand that known variations of the conditions and processes of the following preparative procedures can be used to prepare these compounds. All temperatures are degrees Celsius unless noted otherwise.

Silazanes. Silicon-nitrogen compounds with alternating silicon- (“sila”) and nitrogen atoms (“aza”) are designated as silazanes. Simple examples of silazanes are disilazane H₃Si—NH—SiHs and hexamethyldisazane (H₃C)₃Si—NH—Si(CH₃)₃. If only one silicon atom is bound to the nitrogen atom, the materials are known as silylamines or aminosilanes (for example triethylsilylamine (H₅C₂)₃Si—NH₂). If three silicon atoms are bound to each nitrogen atom, the materials are called silsesquiazanes. Small ring-shaped molecules with a basic network of Si—N are named cyclosilazanes (for example cyclotrisilazane [H₂Si—NH]₃).

Polysilazanes. Polysilazanes are silazane polymers consisting of both large chains and rings showing a range of molecular masses. Polysilazanes are a class of polymers in which silicon and nitrogen atoms alternate to form the basic backbone. Polysilazanes are a preferred category of silazanes utilized in the present invention. A polymer with the general formula (CH₃)₃Si—NH—[(CH₃)₂Si—NH]ₙ—Si(CH₃)₃ is designated as poly(dimethylsilazane). According to the IUPAC rules for the designation of linear organic polymers, the compound would actually be named poly[aza(dimethylsilylene)], and according to the preliminary rules for inorganic macromolecules catena-poly[(dimethylsilicon)-m-aza]. By “polysilazane” is meant any oligomeric or polymeric composition comprising a plurality of Si—N repeat units. By “oligomer” is meant any molecule or chemical compound which comprises several repeat units, generally from about 2 to 10 repeat units. “Polymer”, as used herein, means a molecule or compound which comprises a large number of repeat units, generally greater than about 10 repeat units. Since each silicon atom is bound to two separate nitrogen atoms and each nitrogen atom to two silicon atoms, both chains and rings of the formula [R¹R²Si—NR³]may occur, where R¹-R² can be hydrogen atoms or organic substituents. If all substituents R are H atoms, then the polymer is designated as perhydropolysilazane, polyperhydridosilazane, or inorganic polysilazane ([H₂Si—NH]n). If hydrocarbon substituents are bound to the silicon atoms, the polymers are designated as organopolysilazanes. The synthesis of polyorganosilazanes was first described in 1964 by Krüger and Rochow. C. R. Krüger, E. G. Rochow, J. Polym. Sci. Vol. A2, 1964, 3179-3189, the disclosure of which is incorporated herein by reference. By reacting ammonia with chlorosilanes (ammonolysis), trimeric or tetrameric cyclosilazanes were formed initially and further reacted at high temperatures with a catalyst to yield higher molecular weight polymers. Ammonolysis of chlorosilanes still represents an important synthetic pathway to polysilazanes, but it is not a preferred method of preparation of the polysilazines of the present invention. In the 1960s, the first attempts to transform organosilicon polymers into quasi-ceramic materials were described.^{[2]} At this time, suitable (“pre-ceramic”) polymers heated to 1000° C. or higher were shown to split off organic groups and hydrogen and, in the process, the molecular network is rearranged to form amorphous inorganic materials. Using polymer derived ceramics (PDCs), alternative embodiments of the invention are disclosed here, especially in the area of high-performance, i.e. high temperature and/or work-hardened steel materials. The most important pre-ceramic polymers are polysilanes [R¹R²Si. R¹R²Si]ₙ, polycarbosilanes [R¹R²Si—CH₂], polysiloxanes [R¹R²Si—O]ₙ and polysilazanes [R1R2Si—NR3]ₙ. In polysilazanes, each silicon atom is bound to two nitrogen atoms and each nitrogen atom to at least two silicon atoms (three bonds to silicon atoms are also possible). If all remaining bonds are with hydrogen atoms, perhydropolysilazane [H₂Si—NH]ₙ. In organopolysilazanes, at least one organic substituent is bound to the silicon atom. The amount and type of organic substituents have a predominant influence on the macro-molecular structure of polysilazanes.

Polysilazanes are colorless to pale yellow liquids or solid materials. Conditional of manufacturing, the liquids often contain dissolved ammonia that can be detected by smell, though this is not a preferred embodiment of the present invention and ammonia-free or lowered ammonia preparations are preferred. The average molecular weight can range from a few thousand to approximately 100,000 g/mol while the density normally lies around 1 g/cm³. The state of aggregation and the viscosity are both dependent on the molecular mass and the molecular macrostructure. Solid polysilazanes are produced by chemical conversion of the liquid materials (crosslinking of smaller molecules). The solid materials can be fusible or unmeltable and can be soluble or insoluble in organic solvents. Sometimes, polysilazane solids behave as thermosetting polymers, but in some cases, thermoplastic processing is possible. After the synthesis, an aging process frequently takes place in which dissolved ammonia plays an important role. The R³Si—NH₂ groups resulting from the ammonolysis reaction form silazane units by splitting off ammonia. If ammonia cannot escape, the silazane units can be split again into R³Si—NH₂ groups. Therefore, frequent venting of ammonia can lead to an increase in molecular mass. The most preferred forms of polysilzanes used in the invention are of reduced ammonia content or ammonia free. Also, functional groups that are not bound directly into the polymer backbone can react under suitable conditions (for example Si—H with N—H groups) and increase crosslinking of the rings and chains. An increase in molecular weight can also be observed during storage at higher temperatures or in sunlight.

With contact to water or moisture, polysilazanes decompose more or less quickly. Water molecules attack the silicon atom and the Si—N bond is cleaved. The R³Si—NH—SiR₃ forms R₃Si—NH₂ and HO—SiRs which can further react (condensation) to form RSi—O—SiR₃ (siloxanes). The rate of the reaction with water (or other OH containing materials like alcohols) depends on the molecular structure of the polysilazanes and the substituents. Perhydropolysilazane [H₂Si—NH]ₙ will decompose very quickly and exothermically with contact to water while polysilazanes with large substituents react very slowly. Polysilazanes are not vaporizable because of strong intermolecular forces. Heating polysilazanes results in crosslinking to form higher molecular weight polymers. At temperatures of 100-300° C., further crosslinking of the molecules takes place with evolution of hydrogen and ammonia. If the polysilazane contains further functional groups such as vinyl units, additional reactions can take place. In general, liquid materials will be converted to solids as the temperature increases. At 400-700° C., the organic groups decompose with the evolution of small hydrocarbon molecules, ammonia and hydrogen which are preferably vented off. Between 700 and 1200° C., a highly preferred three-dimensional amorphous network develops containing Si, C and N (“SiCN ceramics”) with a density of ca. 2 g/cm³. A further temperature increase can result in crystallization of the amorphous material and the formation of silicon nitride, silicon carbide and carbon. This so-called pyrolysis of the polysilazanes produces preferred ceramic materials from low-viscosity liquids with very high yield (up to 90%). Due to the organic groups that are often used to give good polymer processability, preferred ceramic yield is normally in the range of 60-80%. For a long time polysilazanes have been synthesized and characterized, and their great potential for many applications was acknowledged. However, up to now, very few products have been developed into a marketable commodity.

The most preferred polysilazane used in a most preferred embodiment of the invention is a commercially available product called Durazane® 1800, available from Merck KGaA of Darmstadt, Germany. This polysilazane is a liquid phase, low-viscosity, solvent-free organic polysilazane resin having the industrial properties of being a coating binder and a polymeric ceramic precursor. Durazane® 1800 exhibits good adhesion, good hardness, hydrophobicity, and good barrier properties. When used as a polymeric ceramic precursor, it yields a preferred pyrolyzed ceramic material that shows excellent high temperature stability, being able to endure peak temperatures of up to 1000° C., which is well within the range of temperatures encountered in the hot-stamping process. It has a high ceramic yield of 80 to 90%, depending on the atmosphere used. Its applications are in the field of high temperature coatings for the protection of metals against corrosion in industrial applications, in the formulation of non-stick high temperature coatings for rollers or molds, and for the infiltration of porous preforms and resin transfer moldings. Durazane 1800 exhibits the following properties: Dry film thickness: 8-10 μm.
Non-cured temperature stability: up to 350-400° C.
Pencil Hardness: up to 5H (DIN EN ISO 15184).
Indentation Hardness (DIN EN ISO 14577-1).
Radical Initiator DCP cured for 2 h @ 150° C.: 60-65 MPa.
Radical Initiator LP cured for 2 h @ 130° C.: 185-200 MPa.
Contact angle water: 90-96°.
Contact angle oil: 42-44°.
Surface energy: 24-26 mN/m.
Polar part: 2-3 mN/m.
Dispersive part: 22-23 mN/m.
Adhesion by cross cut: 0 (DIN EN ISO 2409:2013, where 0=excellent,
5=no adhesion).
Cured temperature stability: up to 1000° C.
Appearance: clear to trace hazy liquid.
Color: Colorless to trace yellow.
Density @25° C.: 0.950-1.050 g/cm3 (ISO 2811-1).
Viscosity @20° C.: 10-40 cP.
Conditions of use:
Pretreatment:
Grease and dust/particle free surface of substrates are required.
Sandblasting of metal substrates is preferred.
Curing conditions:
Optimally cured with radical initiators, which allows a reduction of the curing
temperature or time (for example 2h/150° C. with addition of 0.5-2 wt.-%
dicumylperoxide [DCP] or 2 h/130° C. with addition of 0.5-2 wt.-% Luperox531 M80 [LP]).
Non catalytic curing: 250° C. for 0.5 h; 180° C. for 3-4 h.
Pyrolysis:
Pyrolysis takes place at temperatures >500° C.
Dilution/Formulation:

Dilution: Possible with organic solvents such as alkanes (e.g. heptane, isoalkanes), esters (e.g. ethyl acetate, butyl acetate, propylene glycol, methyl ether acetate), ethers (e.g. THF, di-n butyl ether), aromates (e.g. toluene, xylene) or ketones (e.g. methyl ethyl ketone). The resin reacts in the presence of water, water vapor or alcohols therefore it is important to use above mentioned solvents with lowest possible water content.

Formulation: Durazane® 1800 may be blended with multiple alternative embodiment coating components, including organic pigments, pigment preparations, metal powders (zinc, aluminum), ceramic powders to increase the ceramic properties of the final admixture (silicon nitride, boron carbide, aluminum oxide, boron nitride, silicon nitride) and many co-binders and additives.

Aluminum. Aluminum Pigment as a Source. The preferred metal constituent of the invention is the metal aluminum. In a most preferred embodiment, aluminum is sourced from the use of a suitable aluminum pigment. The most preferred aluminum pigment used in a most preferred embodiment of the invention is a commercially available product called STAPA Hydrolan 501, available from the Eckart division of Altana corporation, of Hartenstein, Germany. STAPA Hydrolan 501 is the most preferred embodiment of the STAPA® Hydrolan line of non-leafing, aluminum pigments. It is used in general industrial, automotive and accessories coatings. STAPA IL HYDROLAN 501, material number 005332, is an aluminum paste, more specifically a pigment paste of flaky aluminum powder produced of pure aluminum with an inorganic coating. Properties that characterize all aluminum pigments for waterborne systems in the HYDROLAN® line of aluminum pigments are that these silica encapsulated pigments are very shear-stable, and that they are off-gassing resistant. The specific gravity is 1.4 kg/I. The solvent used is isopropanol (IL) and the preparation includes miscellaneous lubricants and additives. The pigment composition is aluminum app. 53%.

Powder Characteristics:

| | |
|---|---|
| TI00004 pigment content/non volatile | 58.0-62.0% |
| TI00004 volatile content | 38.0-42.0% |
| TI00005 sieving < 63 μm | 99.9-100.0% |
| TI00009 D 10 | 7.0-11.0 micrometers |
| TI00009 D 50 | 22.0-28.0 micrometers |
| TI00009 D 90 | 44.0-52.0 micrometers |

Aluminum acetylacetonate. Aluminum acetylacetonate (aluminum 2,4-pentanedionate), also referred to as Al(acac)₃, is a preferred aluminum coordination complex with formula Al(C₅H₇O₂)₃, molecular weight 324.31 g/mol, CAS number 13963-57-0. This aluminum coordination complex with three acetylacetone ligands is used as a precursor in the preparation of aluminum oxide films. The molecule has D₃ symmetry, being isomorphous with other octahedral tris(acetylacetonate)s. Aluminum acetylacetonate may additionally be used to prepare transparent superhydrophobic boehmite and silica films by sublimation, to deposit aluminum oxide films by chemical vapor deposition, to deposit aluminum oxide films by chemical vapor deposition, and as a catalyst. Acetylacetonates are coordination complexes derived from acetylacetone and metal salts, most often salts of transition metals, and most preferably aluminum. These compounds allow many metal ions to be soluble in organic solvent, in contrast to most metal salts. This allows them to be used as catalyst precursors and reagents in reactions which occur in organic phase in chemical synthesis. Acetylacetonates are also frequently used as shift reagents in nuclear magnetic resonance (NMR) spectroscopy, a research and analysis technique that exploits magnetic properties of atomic nuclei to provide detailed information about a chemical substance. Aluminum acetylacetonate is commercially available from Sigman-Aldrich of St. Louis, Missouri.

Solvents. Preferred solvents used in admixing the compositions of the invention are organic aromatic solvents. The most preferred organic aromatic solvent is commercially available as Hi Sol 15, which is itself a mixture of the organic aromatic solvents diethylbenzene, 1,2-diethylbenzene, 1,3-diethylbenzene, 1,4-diethylbenzene, 1,2,3-trimethylbenzeie,1,2,4-Trimethylbenzene or 1,3,5-trimethylbenzene, polyethylbenzene, aka solvent naphtha, naphthalene, 2-methylindole, and curnene.

Catalysts. The addition of a suitable catalyst confers the advantage of achieving a customized or preferred drying time or curing time of the coating on the selected steel article. Target drying time or curing time may be achieved, reduced, or increased through selection of the catalyst and adjustment of the amount of the selected catalyst in the admixture. Typically, in the industrial setting the goal will be to reduce drying time and thereby accelerate the entire coating operation. The most preferred catalyst for use in the invention admixture is diazabicycloundecene, 1,8-Diazabicyclo[5.4.0]undec-7-ene, CAS 6674-22-2. This catalyst is commonly used in organic synthesis as a catalyst, a complexing ligand, a non-nucleophilic base, and as a protecting agent if needed during organic synthesis. The most preferred amount of this catalyst is in the range of 0.5 to 5.0% by weight, with the operator having the freedom to adjust the concentration of catalyst upward or downward to optimize the drying time or the cure time of the coating composition.

Bases. The most highly preferred base to use in the admixture of the invention is BEMP-phosphazene (2-tert-Butylimino-2-diethylamino-1,3-dimethylperhydro-1,3,2-diaza phosphorine), CAS 98015-45-3. This base is a member of the family of phosphazene bases. Phosphazenes refer to classes of organophosphorus compounds featuring phosphorus (V) with a double bond between P and N, for example phosphazenes having the formula RN=P(NR₂)₃. Phosphazene bases are strong, uncharged bases that are non-metallic, non-ionic and low nucleophilic bases. They are stronger bases than regular amine or amidine bases. Protonation takes place at the doubly bonded nitrogen atom. Properties of phosphazene bases include the ability to generate in situ highly reactive “naked” anions, e.g. for alkylation reactions or for spectroscopic investigations; that they are applicable in reactions where ionic bases cause solubility problems; that they are useful in reactions where ionic bases are sensitive towards oxidation or acylation; and that they are useful in reactions where ionic bases result in Lewis-acid catalyzed side reactions, for example in aldol reactions, epoxide-opening, hydride shifts, elimination of alkoxide, and polyanion-formation. The addition of a suitable phosphorous base compound confers the additional advantage of achieving a further customized or preferred drying time or curing time of the coating on the selected steel article. Target drying time or curing time may be achieved, reduced, or increased through selection of the phosphorous base and adjustment of the amount of the selected phosphorous base in the admixture.

Methods of Application. The application of the curable protective coating compositions of the present invention may take place by using the application methods known in the prior art such as bar coating, air-knife coating, roll coating, spray coating and dip coating. In those cases in which flat substrates are to be coated, the application preferably takes place in the roller application method. If a substrate is a coil shape, for example a steel coil is to be coated, a pretreatment for Si-based passivation on the steel coil may be applied prior to the application of the coating composition on the substrate. The curable protective coating composition can be applied by roller application onto the steel surface after the steel is manufactured in a steel manufacturing mill, or can be applied by spraying or another suitable dispersive process onto the steel surface in a hot-stamping site. The post-application cured coating polymeric or ceramic product of the invention can also provide corrosion protection to the steel during storage and transfer between two industrial sites. The coating composition can be cured by flashing off at room temperature or by accelerated curing at an elevated temperature, in which case temperatures of preferably up to 300° C. may be employed for the drying and curing of the coating. Preferably, the curable protective coating composition is cured under a temperature 100° C. to 300° C. for a polymeric coating or of 300 to 1000° C. for a ceramic coating. Accelerated curing by means for example of IR radiation, forced-air drying, UV irradiation or electron beam curing may also be useful. The coating can be applied not only to flat substrates but also to coils which are passing through a cold and/or hot forming step, or else the coating can be applied to substrates which have already undergone cold forming.

The coating composition according to the present invention may be applied in so called “direct” or “indirect” hot forming/stamping process. In an indirect process of hot stamping, a flat substrate coated with the protective coating composition is sequentially pre-stamped, heated and then hot stamped. In a direct process, the coated flat substrate is first heated and then hot stamped.

The present coating composition is suitable particularly for the surface coating of a substrate whose surface is composed at least partly of steel. The coating composition is intended in particular for the surface coating of substrates made of carbon steel, and is suitable preferentially for the surface coating of a high-strength steel substrate which, following the surface coating, is subjected to a hot forming operation or hot stamping process, in particular to hot forming at temperatures between 800° C. and about 1000° C., preferably at between about 880° C. and about 970° C. These types of steels are, for example, duplex steels alloyed with chromium, nickel, and manganese, and boron-manganese steels.

In addition, it is possible where appropriate to add commercially customary wetting/dispersion agents, thickeners, setting agents, rheological agents, leveling agents, defoamers, hardness improving agents, lubricants and coating film modifiers or the like, all according to product performance parameters chosen through the skills of the ordinary practitioner in the art to achieve specified properties of the coating or of the coated product. Suitable examples of coating film modifiers are cellulosic materials, such as cellulose esters and cellulose ethers; homopolymers or copolymers from styrene, vinylidene chloride, vinyl chloride, alkyl acrylate, alkyl methacrylate, acrylamide, methacrylamide, acrylonitrile, methacrylonitrile, vinyl ether, and vinyl acetate monomers; polyesters or copolyesters; polyurethanes or polyurethane acrylates; epoxy resins; polyvinylpyrrolidone; polytetrafluoromethylene, polyphenyl, polyphenylene, polyimide and polytetrafluoroethylene.

The most preferred compounds of the invention are any or all of those specifically set forth in these Examples. These compounds are not, however, to be construed as forming the only genus that is considered as the invention, and any combination of the compounds or their moieties may itself form a genus. The following examples further illustrate details for the preparation, application, quantitative analysis and qualitative analysis of the compounds of the coatings of the present invention. Those skilled in the art will readily understand that known variations of the conditions and processes of the following preparative procedures can be used to prepare these compounds. All temperatures are degrees Celsius unless noted otherwise.

### Example 1

Into a suitably sized mixing vessel were added 445 pounds of Hi Sol 15 Aromatic 150 organic solvent, 145 pounds of Hydrolan Aluminium 501 aluminum pigment, 389.45 pounds of Durazane 1800 Polysilizane, and 20.55 pounds of 1,8-diazabicycloundecene catalyst, which were then mixed under medium speed agitation until a lump free, smooth, and homogeneous mixture was achieved; estimated curing time of the admixture was adjusted by titrating the admixture with the addition of aluminum acetylacetonate and adding 2-tert-butylimino-2-diethylamino-1,3-dimethylperhydro-1,3,2-diazaphosphorine base. The resulting mixture was analyzed and found to not exceed 6.5 hegman cure to 350 f pmt for 30 seconds to a hardness of 2 h min at 0.4 mils dry film thickness.

### Example 2

Into a suitably sized mixing vessel were added 444 pounds of Hi Sol 15 Aromatic 150 organic solvent, 120 pounds of Hydrolan Aluminium 501 aluminum pigment, 415 pounds of Durazane 1800 Polysilizane, and 20.55 pounds of 1,8-diazabicycloundecene catalyst, which were then mixed under medium speed agitation until a lump free, smooth, and homogeneous mixture was achieved; estimated curing time of the admixture was adjusted by titrating the admixture with the addition of aluminum acetylacetonate and adding and 2-tert-butylimino-2-diethylamino-1,3-dimethylperhydro-1,3,2-diazaphosphorine base. The resulting mixture was analyzed and found to not exceed 6.5 hegman cure to 350 f pmt for 30 seconds to a hardness of 2 h min at 0.4 mils dry film thickness.

### Example 3

Into a suitably sized mixing vessel were added 404.9 pounds of Hi Sol 15 Aromatic 150 organic solvent, 255.4 pounds of Hydrolan Aluminium 501 aluminum pigment, 349.7 pounds of AW Hawthore Polysilizane, and Indopol as needed to achieve a desired admixture flow, which were then mixed under medium speed agitation until a lump free, smooth, and homogeneous mixture was achieved The resulting mixture was analyzed was found to not exceed 6.5 hegman cure to 350 f pmt for 30 seconds to a hardness of 2 h min at 0.4 mils dry film thickness.

### Example 4

Into a suitably sized mixing vessel are added 444 pounds of Hi Sol 15 Aromatic 150 organic solvent, 175 pounds of Hydrolan Aluminium 501 aluminum pigment, 300 pounds of Durazane 1800 Polysilizane, and 15 pounds of 1,8-diazabicycloundecene catalyst, which is then mixed under medium speed agitation until a lump free, smooth, and homogeneous mixture was achieved; estimated curing time of the admixture is adjusted by titrating the admixture with the addition of aluminum acetylacetonate and adding and 2-tert-butylimino-2-diethylamino-1,3-dimethylperhydro-1,3,2-diazaphosphorine base. The resulting mixture should show analysis of not to exceed 6.5 hegman cure to 350 f pmt for 30 seconds to a hardness of 2 h min at 0.4 mils dry film thickness.

### Example 5

Into a suitably sized mixing vessel are added 444 pounds of Hi Sol 15 Aromatic 150 organic solvent, 175 pounds of Hydrolan Aluminium 501 aluminum pigment, 500 pounds of Durazane 1800 Polysilizane, and 15 pounds of 1,8-diazabicycloundecene catalyst, which is then mixed under medium speed agitation until a lump free, smooth, and homogeneous mixture is achieved; estimated curing time of the admixture is adjusted by titrating the admixture with the addition of aluminum acetylacetonate and adding and 2-tert-butylimino-2-diethylamino-1,3-dimethylperhydro-1,3,2-diazaphosphorine base. The resulting mixture should show analysis of not to exceed 6.5 hegman cure to 350 f pmt for 30 seconds to a hardness of 2 h min at 0.4 mils dry film thickness.

Ordinarily skilled inorganic and organic chemists and chemical engineers may modify the compositional embodiments within the specifications' teachings according to methods well known to those of ordinary skill in the arts, to provide numerous preferred alternative embodiments for a particular physico/chemical/material/structural set of desired performance parameters of coated sheet steel articles, without rendering such embodiments unstable or compromising their advantageous manufacturing characteristics.

While the above description contains a great deal of specificity, these should not be construed as limitations on the scope of any embodiment, but as exemplifications of the presented embodiments thereof. Many other alternative embodiments and variations are possible within the teachings of the various embodiments. While the invention has been described with reference to exemplary embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention will not be limited to the particular embodiments expressly disclosed as the best mode contemplated for carrying out this invention, but that the invention will include all embodiments falling within the scope of the appended claims. Moreover, unless the text specifically reads otherwise, the use of the terms first, second, and so forth do not denote any order or hierarchy of importance, but rather the terms first, second, and so forth are used to distinguish one disclosed element from another. Furthermore, the use of the terms a, an, etc. do not denote a limitation of quantity, but rather denote the presence of at least one of the referenced items.

While the invention has been described, exemplified, and illustrated in reference to certain preferred embodiments thereof, those skilled in the art will appreciate that various changes, modifications, and substitutions can be made therein without departing from the spirit and scope of the invention.

It is intended, therefore that the invention be limited only by the scope of the claims which follow, and that such claims be interpreted as broadly as is reasonable.

What is claimed is:

1. A steel sheet for hot-stamping, comprising said steel sheet having at least one surface coated by a composition comprising:
(a) an aromatic organic solvent;
(b) a source of aluminum;
(c) a silazane; and
(d) an organic synthesis catalyst.
